(19) United States
(12) Patent Application Publication
(10) Pub. No.: US 2016/0368602 A1
(43) Pub. Date: Dec. 22, 2016

(54) CAMERA DRONE SYSTEMS AND METHODS FOR MAINTAINING CAPTURED REAL-TIME IMAGES VERTICAL

(71) Applicant: Chengdu CK Technology CO., LTD., Chengdu (CN)

(72) Inventor: Shou-chuang ZHANG, Chengdu (CN)

(21) Appl. No.: 15/145,640

(22) Filed: May 3, 2016

(30) Foreign Application Priority Data
Jun. 16, 2015 (CN) 2015204141403

(51) Int. Cl. B64C 39/02; H04N 5/44; G06T 7/00; G06T 7/60; H04N 7/18; H04N 5/262

(52) U.S. Cl. CPC B64C 39/024; H04N 7/183; H04N 5/2628; G06T 7/004; G06T 7/60; H04N 5/44; B64C 2201/024; B64C 2201/108; B64C 2201/127

(57) ABSTRACT

A camera drone with a function of providing real-time captured images in a certain angle (e.g., vertical to the horizon) is disclosed. The camera drone includes multiple rotor wings, a support structure, a wireless transmitter, a controller, and a camera device. The camera device includes a processor, a gravity sensor, a gyroscope, and an image module. The image module is configured to capture an original image in a real time manner. The gravity sensor and the gyroscope are used to calculate a current dip angle (i.e., inclination of a geological plane down from the horizon) of the camera drone. The current dip angle is used to calculate an angle of rotation. The camera device then generates an edited image based on the original image and the angle of rotation.

### CROSS-REFERENCE TO RELATED APPLICATIONS

This application claims the benefit of Chinese Patent Application No. 2015204141403, filed Jun. 16, 2015 and entitled “CAMERA DRONES WITH A FUNCTION OF KEEPING REAL-TIME RECORDING IMAGES VERTICAL,” the contents of which are hereby incorporated by reference in its entirety.

### BACKGROUND

Drones with cameras are widely used in various fields such as collecting images for television shows or natural/geographical observations. Drones with cameras are also used for important events such as large ceremonies. Collecting images while a drone is moving usually results in tilted images, which can cause inconvenience or problems when a user later wants to use these tilted images. Corrections or further edits of these tilted collected images are usually time consuming and expensive. Some people tried to resolve this problem by rotating the cameras by certain mechanical systems (such as a ball head or a cradle head) while the drones are operating. However, these mechanical systems are relatively slow in response to the movement of the drones and can be expensive. Therefore, it is advantageous to have a system that can effectively and efficiently address this problem.

### BRIEF DESCRIPTION OF THE DRAWINGS

Embodiments of the disclosed technology will be described and explained through the use of the accompanying drawings.

FIG. 1 is a schematic diagram illustrating a camera drone system in accordance with embodiments of the disclosed technology.

FIGS. 2A and 2B are block diagrams illustrating camera devices used in the camera drone system in accordance with embodiments of the disclosed technology.

FIGS. 3A and 3B are schematic diagrams illustrating how to calculate an angle of rotation based on a dip angle.

FIG. 3C is a schematic diagram illustrating an originally-captured image and an edited image in accordance with embodiments of the disclosed technology.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “one embodiment”, “some embodiments,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure provides a camera drone system that can maintain collected real-time images in a certain view angle. More particularly, for example, the camera drone system can keep captured images in a view angle vertical to the horizon. The camera drone system includes a camera device having a gravity sensor (e.g., an acceleration sensor) and a gyroscope. The gravity sensor and the gyroscope are configured to measure a current dip angle (i.e., inclination of a geological plane down from the horizon) of the camera device. Based on the measured current dip angle, the camera device can accordingly adjust the captured images in a real-time fashion (e.g., edit the captured images based on a predetermined algorithm associated with the current dip angle). For example, based on the current measured dip angle, the camera device can identify/track an object-of-interest and then cut a portion of the captured images so as to form edited images that includes the object-of-interest in the center of the edited images and that are vertical to the horizon. By this arrangement, the camera device can instantaneously provide a user with ready-to-use captured images in a fixed view angle.

The camera drone in accordance with the present disclosure includes a multiple rotor wings, a support structure, a wireless transmitter, a controller, and a camera device. The rotor wings are configured to move the camera drone. The support structure is configured to support or carry other components of the camera drone. The wireless transmitter is configured to receive signals from a remote control unit, transmit captured images to a remote server, etc. The controller is configured to control the rotor wings, the wireless transmitter, and the camera device. In some embodiments, the camera device can be fixedly or rigidly attached to the support structure by a screw.

The camera device further includes a processor, a gravity sensor, a gyroscope, an image module, a storage unit, a display module, and a user interface (e.g., a button for a user to interact with the camera device). The gravity sensor and the gyroscope are used to measure a current dip angle (i.e., inclination of a geological plane down from the horizon) of the camera drone. Based on the measured result, the images collected by the image module can be edited accordingly, so as to generate real-time images in a predetermined angle (e.g., vertical to the horizon). As a result, the camera drone can provide a user with real-time images in a predetermined view angle, such that these images are ready-to-use without further edits (e.g., no need to convert the images to fit a specific format).

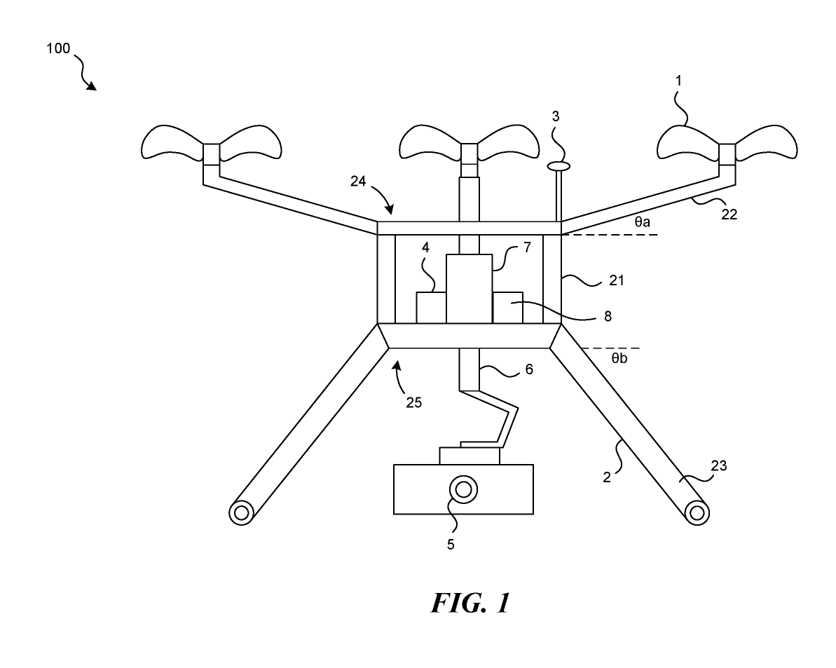

FIG. 1 is a schematic diagram illustrating a camera drone system 100 in accordance with embodiments of the disclosed technology. As shown, the camera drone system 100 includes multiple rotor wings 1, a support structure 2, a wireless transmitter 3, a controller 4, a camera device 5, a camera connector 6, a controller connector 7, and a tilt sensor 8. The support structure 2 includes a center frame portion 21, multiple arm components 22, and multiple leg components 23. The center frame portion 21 is configured to support the controller connector 7, the controller 4, and the wireless transmitter 3. In some embodiments, the controller 4 is coupled to the center frame portion 21 by the controller connector 7. In other embodiments, however, the controller 4 can be coupled to the center frame portion 21 directly. In some embodiments, the wireless transmitter 3 is positioned on an edge of the center frame portion 21. In some embodiments, the wireless transmitter 3 can be positioned adjacent to an upper portion of the center frame portion 21. In other embodiments, the wireless transmitter 3 can be positioned at any suitable places of the center frame portion 21.

The arm components 22 are configured to support the rotor wings 1. In some embodiments, each arm component 22 is configured to support a corresponding one of the rotor wings 1. In some embodiments, the arm components 22 are positioned circumferentially around the center frame portion 21. As shown in FIG. 1, each of the arm components 22 is positioned to form a first angle θa with an upper surface 24 of the center frame portion 21. In other embodiments, however, individual arm components 22 can be positioned to form different first angles with the upper surface 24 of the center frame portion 21.

The leg components 23 are configured to support the camera drone system 100 when it is placed on the ground. In some embodiments, the leg components 23 can be positioned so as to protect the camera device 5 from possible impact caused by other objects (e.g., a bird flying near the drone camera system 100 during operation). In some embodiments, the leg components 23 can be positioned circumferentially around the center frame portion 21. As shown in FIG. 1, each of the leg components 23 is positioned to form a second angle θb with a lower surface 25 of the center frame portion 21. In the illustrated embodiment shown in FIG. 1, the second angle θb is greater than the first angle θa. In other embodiments, the second angle θb can be smaller than or equal to the first angle θa. In some embodiments, the first angle θa can be about 30 degrees, and the second angle θb can be about 45 degrees.

As shown in FIG. 1, the camera device 5 is fixedly or rigidly coupled to the center frame portion 21 by the camera connector 6 (e.g., the camera device 5 does not rotate relatively to the center frame portion 21). In the illustrated embodiment, the camera connector 6 is a U-shaped member. In some embodiments, the camera connector 6 can function as a damper so as to protect the camera device 5 from undesirable vibration caused by the rotor wings 1. In some embodiments, the camera connector 6 is also coupled to the controller connector 7.

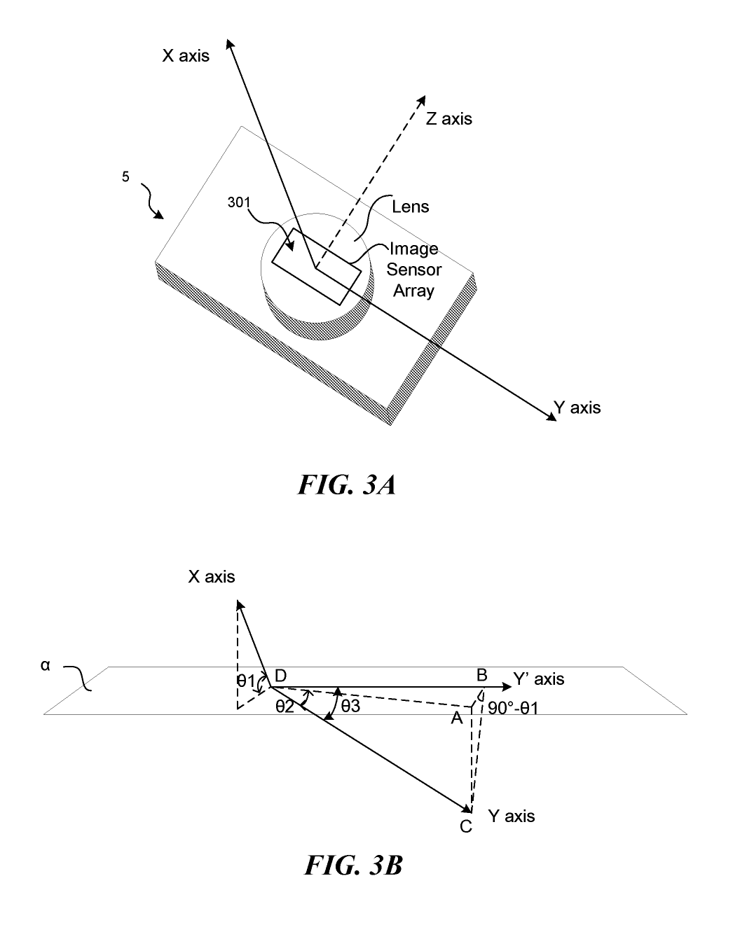

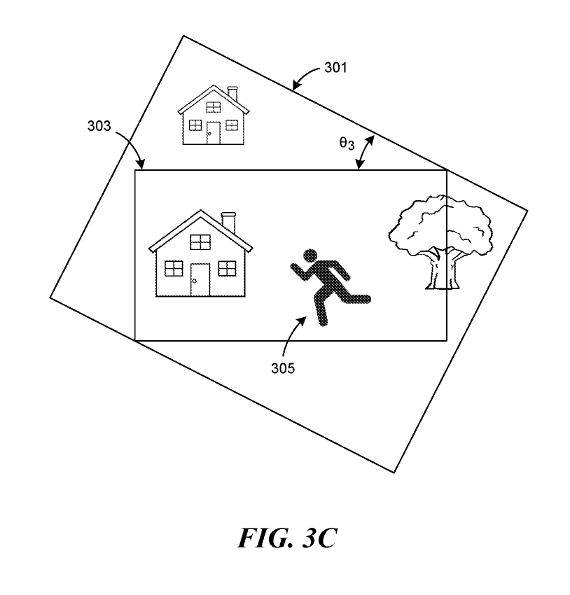

In some embodiments, the tilt sensor 8 can be mounted on or built in the camera device 5. The tilt sensor 8 is configured to provide a dip angle signal that indicates a real-time dip angle of the camera drone system 100. In some embodiments, the tilt sensor 8 can be a 2-axis tilt sensor (as discussed in detail below with reference to FIGS. 3A and 3B). In some embodiments, the tilt sensor 8 can include an independent processor, a gravity sensor and a gyroscope. The gravity sensor is configured to generate an accelerating signal and the gyroscope is configured to generate an angular signal. The independent processor can generate a dip angle signal to indicate a real-time dip angle of the drone camera system 100 based on the accelerating signal and the angular signal. Algorithms for calculating the dip angle based on the accelerating signal and the angular signal include, for example, Kalman Filtering or linear quadratic estimation (LQE). One with ordinary skills in the art would understand that, in other embodiments, the tilt sensor 8 is not limited by the above-described structure. As an example, the tilt sensor 8 can alternatively include an inclinometer or a magnetometer (e.g., use a magnetic field to determine a direction). In some embodiments, the tilt sensor 8 need not include an independent processor and can be coupled to and controlled by a processor of the camera device 5.

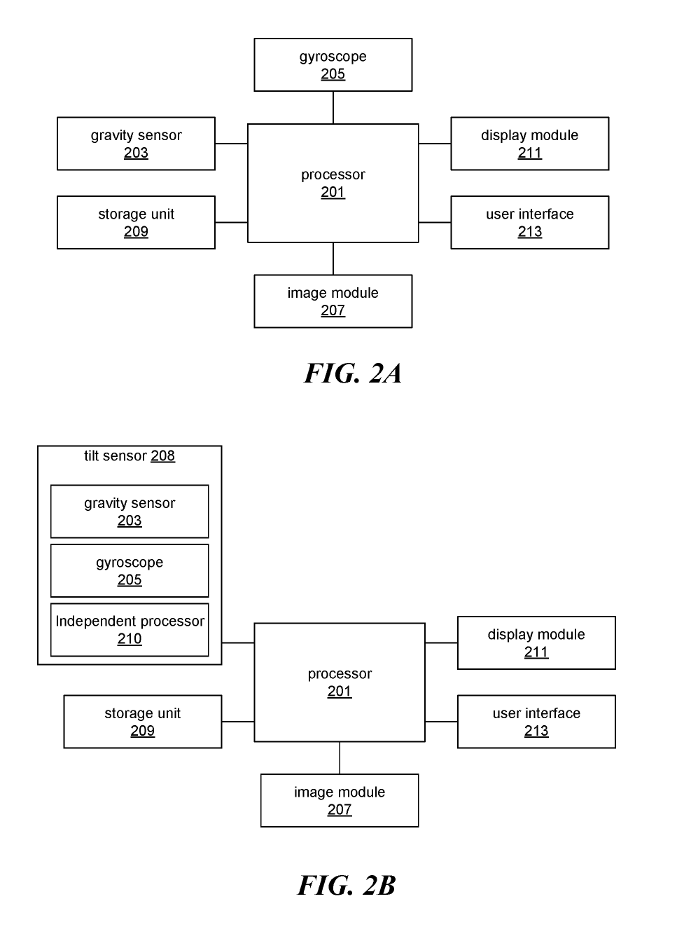

FIG. 2A is a block diagram illustrating the camera device 5 in accordance with embodiments of the disclosed technology. The camera device 5 includes a processor 201, a gravity sensor 203, a gyroscope 205, an image module 207, a storage unit 209, a display module 211, and a user interface 213. The processor 201 is coupled with and configured to control other components of the camera device 5. The image module 207 is configured to capture real-time images and can include an image sensor array (e.g., a CMOS sensor or a CCD sensor) and a group of lens. The processor 201 receives the real-time images from image module 207, an accelerating signal from the gravity sensor 203, and an angular signal from the gyroscope 205. The processor 201 then generates a dip angle signal to indicate a real-time dip angle of the drone camera system 100 based on the accelerating signal and the angular signal (e.g., by the Kalman Filtering algorithm discussed above). The processor 201 then calculates an angle of rotation (e.g., a two-dimensional angle) based on the real-time dip angle (e.g., a three-dimensional angle). The calculations between the real-time dip angle and the angle of rotation will be discussed in detail below with reference to FIGS. 3A and 3B. When the angle of rotation is derived, the processor 201 can then edit the captured images based on the angle of rotation. In some embodiments, for example, the processor 201 can cut a portion out of the captured images so as to form images with a side edge vertical to the horizon and a bottom edge parallel to the horizon (details please refer to FIG. 3C and corresponding description below). The storage unit 209 is configured to store measured information, captured images, edited captured images, statuses of the components, etc. The display module 211 is configured to display captured and/or edited images to a user. The user interface 213 is configured to enable a user to interact with the camera device 5. In some embodiments, the user interface 213 includes a button that enables a user to control the camera device 5.

FIG. 2B is another block diagram illustrating the camera device 5 in accordance with embodiments of the disclosed technology. As shown, the camera device 5 includes a processor 201, an image module 207, a tilt sensor 208, a storage unit 209, a display module 211, and a user interface 213. The tilt sensor 208 further includes a gravity sensor 203, a gyroscope 205, and an independent processor 210. Compared to the embodiments discussed in FIG. 2A above, the independent processor 210 (rather than the processor 201) receives an accelerating signal from the gravity sensor 203 and an angular signal from the gyroscope 205. The independent processor 210 then generates a dip angle signal to indicate a real-time dip angle of the drone camera system 100 based on the accelerating signal and the angular signal. In some embodiments, the independent processor can further calculate an angle of rotation based on the real-time dip angle. In other embodiments, however, the angle of rotation can be calculated by the processor 201. In some embodiments, the tilt sensor 208 need not have an independent processor and can be directly controlled by the processor 201.

FIGS. 3A and 3B illustrate how to calculate an angle of rotation based on a dip angle. In FIG. 3A, two measuring axes (i.e., X axis and Y axis) corresponding to a 2-axis tilt sensor are defined for a dip angle measurement. The X axis is perpendicular to a focal plane 301 of the camera device 5 (i.e. where the image sensor array is located). As shown, the Y axis is in the focal plane 301 and parallel to a bottom edge (i.e., the long edge shown in FIG. 3A) of the image sensor array. One with ordinary skills in the art would know that the above definition of the axes is for an illustrative purpose and not intended to limit the present disclosure. In other embodiments, the Y axis can be parallel to a side edge (i.e., the short edge shown in FIG. 3A) of the image sensor array. In some embodiments, the number of measuring axes can vary according to the types or models of the tilt sensor used in the drone camera system 100.

A dip angle signal can include two components that indicate a first dip angle θ1 and a second dip angle θ2 respectively. As shown in FIG. 3B, the first dip angle θ1 represents an angle between the X axis and the horizontal plane (i.e., plane α). The second dip angle θ2 represents an angle between the Y axis and the horizontal plane. Both θ1 and θ2 are acute angles (no larger than 90 degrees). As shown in FIG. 3B, Point C is a point on the Y axis. Point A is the vertical projection of Point C on the horizontal plane. Point D is the intersection of the X axis and Y axis. Y′ axis is defined by the intersection between the horizontal plane and the focal plane. Dash line BC is perpendicular to the Y′ axis. The angle of rotation θ3 is consequently defined as the angle between the Y axis and the Y′ axis.

Since Point A is the vertical projection of point C on the horizontal plane, dash line AC is perpendicular to the horizontal plane. Accordingly, angle ABC is the dihedral angle between the horizontal plane and the focal plane. Also, angel ABC is (90-θ1) degrees. Therefore, the following equations explain the relationships among angles θ1, θ2, and θ3.

$$\begin{matrix}sin θ 2 = \frac{AC}{CD} & ( 1 ) \\ sin ( 90 ° - θ 1 ) = \frac{AC}{BC} & ( 2 ) \\ sin θ 3 = \frac{BC}{CD} & ( 3 )\end{matrix}$$

Accordingly, angle θ3 can be calculated based on angles θ1 and θ2. For example:

$$\begin{matrix}sin θ 3 = \frac{sin θ 2}{sin ( 90 ° - θ 1 )} & ( 4 ) \\ θ 3 = arcsin [ \frac{sin θ 2}{sin ( 90 ° - θ 1 )} ] , ( - 90 ° < θ 3 < 90 ° ) & ( 5 )\end{matrix}$$

According to geometry, the dihedral angle ABC is larger than angle θ2. Therefore the equation (5) always has a real root for the angle of rotation θ3.

In some embodiments, when a calculated angle of rotation θ3 is less than or equal to 45 degrees, the camera device 5 can adjust the captured image by rotating the image by θ3 degrees. When the calculated angle of rotation θ3 is larger than 45 degrees, the camera device 5 can adjust the captured image by rotating the image by (90-θ3) degrees.

FIG. 3C is a schematic diagram illustrating an originally-captured image 301 and an edited image 303 in accordance with embodiments of the disclosed technology. As shown in FIG. 3C, the originally-captured image 301 illustrates an image captured by the image module 207. The originally-captured image 301 includes an object-of-interest (e.g., a person, a structure, a moving object, etc.) 305. Due to the movement of the camera drone 100, the object-of-interest 305 in the originally-captured image 301 may not be in a desirable view angle. For example, a user may want to have a picture or a person that is vertical to the horizon. However, the person in an originally-captured image can be tilted. In such case, the camera device 5 can calculate the angle of rotation θ3 of the camera device 5, and then edit the originally-captured image 301 accordingly. In the illustrated embodiment shown in FIG. 3, the edited image 303 is generated by cutting a portion out of the originally-captured image 301. As shown, the originally-captured image 301 and the edited image 303 form an angle equal to the angle of rotation θ3 (in some embodiments, an angle with (90-θ3) degrees). Therefore, the bottom edge of the edited image 303 is parallel to the horizontal plane. As a result, the camera device 5 can provide a user with edited images having a predetermined view angle on a real-time basis. In some embodiments, the predetermined view angle can be set as vertical to the horizon. In other embodiments, however, the predetermined view angle can be configured based on user's preferences.

In some embodiments, the system 100 can first identify the object-of interest 305 in the originally-captured image 301 and continuously tracking it, so as to make sure that the object-of interest 305 is in a center portion of the edited image 303. In some embodiments, the edited image 303 can be generated by a predetermined algorithm, suitable computer-implementable software/firmware, suitable applications, etc.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A camera drone, comprising:
multiple rotor wings configured to drive the camera drone,
a support structure having a center frame portion, and multiple arm components corresponding to the multiple rotor wings;
a wireless transmitter configured to couple with the center frame potion;
a controller coupled to the center frame portion;
a camera device configured to capture an original image and to generate an edited image based on an angle of rotation calculated from a current dip angle, wherein the edited image is in a predetermined view angle; and
a camera connector rigidly coupled to the camera device and the center frame portion.

2. The camera drone of claim 1, wherein the camera device includes a processor, a tilt sensor, an image module, a storage unit, a display module, and a user interface.

3. The camera drone of claim 2, wherein the current dip angle is calculated based on a measurement performed by the tilt sensor.

4. The camera drone of claim 1, further comprising a controller connector configured to couple the controller to the center frame portion.

5. The camera drone of claim 1, wherein the wireless transmitter is positioned on an edge of the center frame portion.

6. The camera drone of claim 1, wherein the wireless transmitter is positioned adjacent to an upper portion of the center frame portion.

7. The camera drone of claim 1, wherein the multiple arm components are positioned to form a first angle with an upper surface of the center frame portion, and wherein the multiple leg components are positioned to form a second angle with a lower surface of the center frame portion.

8. The camera drone of claim 7, wherein the second angle is greater than the first angle.

9. The camera drone of claim 1, wherein the camera connector includes a U-shaped member.

10. The camera drone of claim 1, wherein the camera connector includes a damper.

11. The camera drone of claim 1, wherein the predetermined view angle is vertical to the horizon.

12. The camera drone of claim 1, wherein the edited image is generated by cutting a portion of the original image.

13. The camera drone of claim 1, wherein the support structure further includes multiple leg components circumferentially positioned around the camera device.

14. A method for generating real-time images in a predetermined view angle, the method comprising:
collecting an original image on a real-time basis by a camera device carried by a drone, wherein the drone includes a support structure having a center frame portion, and multiple arm components corresponding to multiple rotor wings, and wherein the camera device includes a storage unit, a gravity sensor, and a gyroscope;
generating a current dip angle based on a measurement performed by the gravity sensor and the gyroscope;
identifying an object-of-interest in the original image;
calculating an angle of rotation based on the current dip angle;
generating an edited image based on the original image and the angle of rotation, wherein the object-of-interest is positioned in a center portion of the edited image;
storing the edited image in the storage unit; and
transmitting the edited image to a remote server.

15. The method of claim 14, wherein identifying the object-of-interest in the original image includes constantly tracking the object-of-interest in the original image.

16. The method of claim 14, wherein the edited image is generated by cutting a portion of the original image.

17. The method of claim 14, wherein the support structure includes multiple leg components circumferentially positioned around the camera device.

18. A camera drone system, comprising:
a support structure having a center frame portion and multiple arm components;
multiple rotor wings configured to move the camera drone system and circumferentially positioned around the center frame portion, wherein each of the rotor wings is coupled to a corresponding one of the arm components;
a camera device configured to capture an original image and to generate an edited image based on an angle of rotation, wherein the angle of rotation is calculated based on a current dip angle measured by a tilt sensor, and wherein the edited image and the original image form an angle equal to the current dip angle; and
a U-shaped camera connector rigidly coupled to the camera device and the center frame portion.

19. The system of claim 18, wherein the U-shaped camera connector is coupled to a controller connector positioned in the center frame portion.

20. The system of claim 19, further comprising:
a wireless transmitter configured to couple with the center frame potion;
a controller coupled to the center frame portion by the controller connector; and
multiple leg components circumferentially positioned around the center frame portion.
